(19) United States
(12) Patent Application Publication
(10) Pub. No.: US 2009/0106293 A1
(43) Pub. Date: Apr. 23, 2009

(54) MULTIDIMENSIONAL FORECASTING

(75) Inventors: Rajit K. Joseph, San Ramon, CA (US); Ravi C. Doraiswamy, Bangalore (IN); Jigar P. Vachharajani, Bangalore (IN)

Correspondence Address: CAMPBELL STEPHENSON LLP, 11401 CENTURY OAKS TERRACE, BLDG. H, SUITE 250, AUSTIN, TX, 78758, US

(73) Assignee: ORACLE INTERNATIONAL CORPORATION, Redwood Shore, CA (US)

(21) Appl. No.: 11/875,610

(22) Filed: Oct. 19, 2007

(51) Int. Cl. G06F 17/30

(52) U.S. Cl. 707/102; 707/E17.044

(57) ABSTRACT

An apparatus and method for multidimensional forecasting. In one embodiment of the method a database is accessed to select a set of data objects each of which has a date field that contains a date that falls within a predefined time period. The data contained in a first field of each of the set of data objects is summed thereby generating a first total. The data contained in the first field of each of a first subset of the set of data objects is summed thereby generating a first subset total. A user interface is then displayed on a monitor of a computer system, wherein the user interface, when displayed, comprises graphical representations of the first total and the first subset total.

### BACKGROUND

Many businesses track their sale opportunities (i.e. an opportunity to sell products). By tracking various sale opportunities, a business can forecast statistics such as revenue and product quantities based on the opportunities. In addition, organizations generally would like to monitor how their actual revenue relates to their forecasted revenue based on actual-to-forecasted statistics. By monitoring actual revenue, an organization can determine whether it is on track to meet its forecasted revenue.

Traditionally, each sales person in a business would track their own opportunities and, when requested, would provide their forecasts to their sales manager. A forecast can be seen as a snapshot of sales opportunities for a given period of time. Upon receiving these forecasts, a sales manager might create a spreadsheet that totals the forecasts of all the sales people reporting to that sales manager. That sales manager would then provide a summary of the forecast to a regional or divisional sales manager, and so on.

### SUMMARY

An apparatus and method for multidimensional forecasting. In one embodiment of the method a database is accessed to select a set of data objects each of which has a date field that contains a date that falls within a predefined time period. The data contained in a first field of each of the set of data objects is summed thereby generating a first total. The data contained in the first field of each of a first subset of the set of data objects is summed thereby generating a first subset total. A user interface is then displayed on a monitor of a computer system, wherein the user interface, when displayed, comprises graphical representations of the first total and the first subset total.

### DESCRIPTION OF THE DRAWINGS

The example embodiments may be better understood, and its numerous objects, features and advantages made apparent to those skilled in the art by referencing the accompanying drawings.

FIG. 1 is a simplified block diagram of a data processing system.

FIGS. 2A and 2B illustrate example interfaces that list opportunities.

FIGS. 3A and 3B illustrate example interfaces for creating a new opportunity.

FIGS. 4A and 4B illustrate example interfaces that list forecasts.

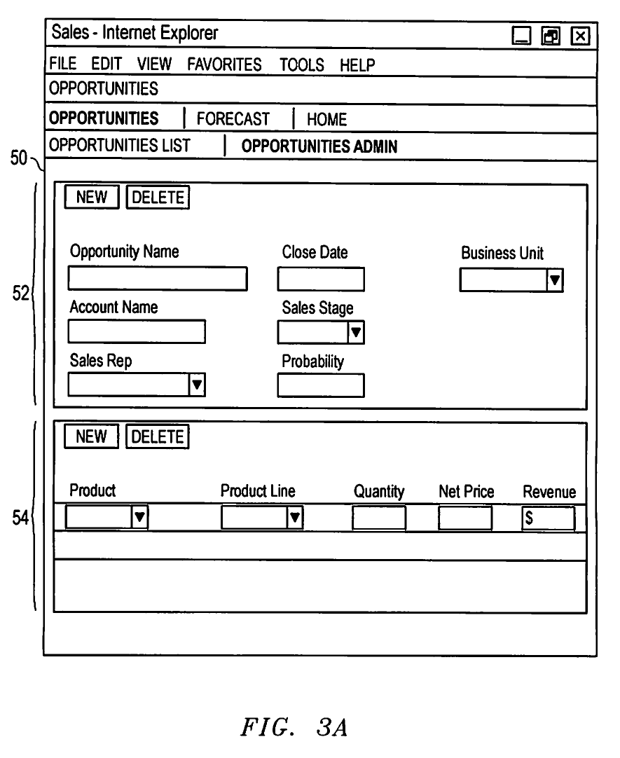

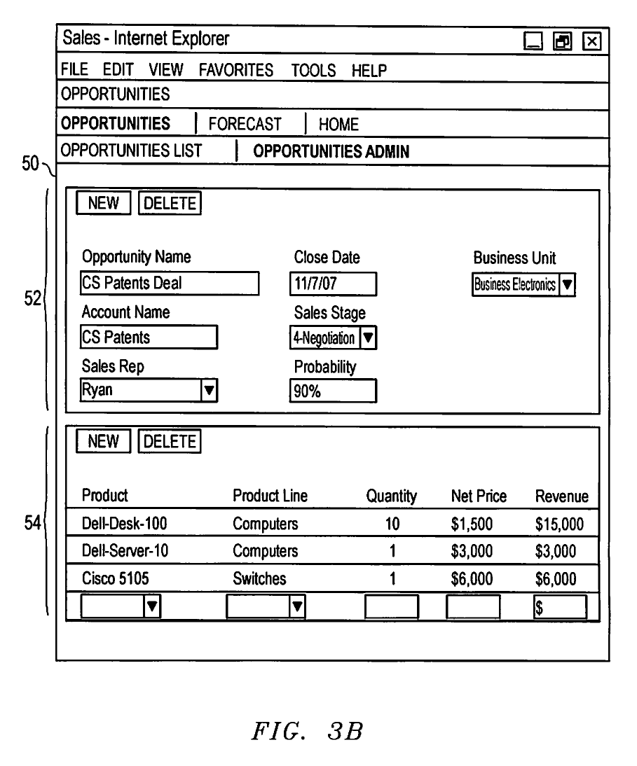

FIGS. 3A and 3B illustrate example interfaces for creating a new forecast definition.

FIGS. 6 and 7 illustrate example interfaces that display a forecast.

### DETAILED DESCRIPTION

Software solutions have been developed that allow businesses to track their forecasts and the supporting opportunities. Often, these enterprise-based software solutions operate on opportunity data that are stored in records of one or more underlying relational databases. After running a forecast using these software solutions, sales representatives and managers can either view the forecasted revenue and product quantity line-by-line for the forecast period, or alternatively view the total revenues and total product quantities for the forecast period. The former view could easily become overwhelming and hard to manage especially when there are a large number of opportunities involving many different products, while the latter view may not provide enough details.

The present invention provides a method and system for generating multidimensional forecasting in summary view, which enables sales people and/or managers to view product revenues and product quantities of opportunities that are grouped and displayed by different opportunity attributes such as account, product line, product, etc.

The present invention can be implemented as one or more computer programs executing on one or more processors of one or more computer systems, although those skilled in the art will readily recognize that the equivalent of such software may also be constructed in hardware or a combination of hardware and software. If the invention is implemented as a computer program, the program may be stored on one or more conventional computer-readable mediums that may include, for example: magnetic storage media such as a magnetic disk (e.g., a disk drive); optical storage media such as an optical disk; solid state electronic storage devices such as Random Access Memory (RAM), or Read Only Memory (ROM); or any other device or medium employed to store computer program instructions.

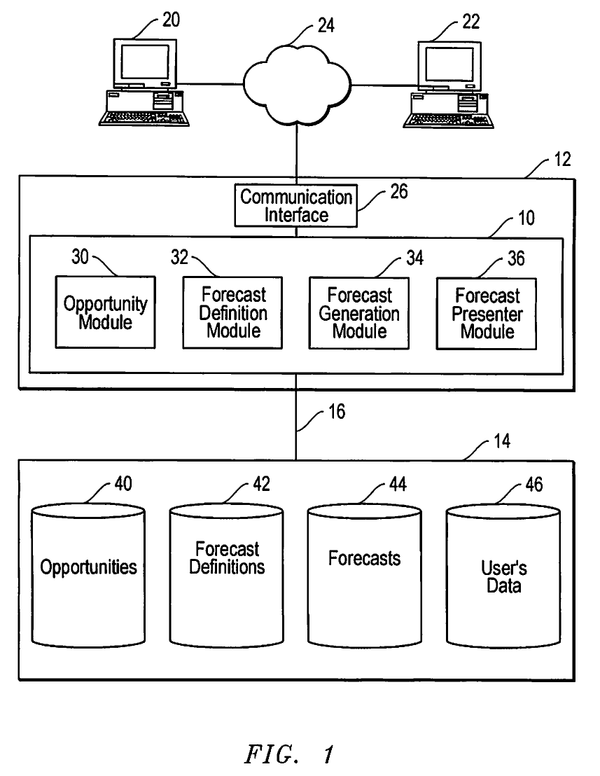

FIG. 1 illustrates in block diagram form, relevant components of an example data processing system that includes a forecasting system 10 executing on one or more processors of a server 12. Server 12, in turn, is coupled to a memory system 14 via a communication link 16. Although not shown, communication link 16 may include one or more software and/or hardware components such as a volume manager, database manager, routers, switches, etc. Memory system 14 may take form in one or more memory devices such as disk arrays. In addition to being in data communication with memory system 14, server 12 is also in data communication with client computer systems 20 and 24 via a network 24, which may take form in a Local Area Network (LAN) or a Wide Area Network (WAN) such as the Internet. For purposes of explanation, it will be presumed that network 24 takes form in the Internet.

Forecasting system 10, as shown in FIG. 1 includes four distinct modules that are designated opportunity module 30, forecast definition module 32, forecast generation module 34, and forecast presenter module 36. Modules 30-36 will be more fully described below. Each of these modules is in data communication with software executing on clients 20 and 22. In one embodiment, clients 20 and 22 can communicate with forecasting system 10, including modules 30-36 thereof, via a conventional web browser.

As noted, memory system 14 may take form in one or more memory devices such as disk arrays. Memory system 14, as shown, includes four logical memories 40-44. Each of the logical memories store data objects that are accessible by modules 30-36. Memory 40 stores opportunities as data objects; memory 42 stores forecast definitions as data objects; memory 44 stores forecasts as data objects, and; memory 46 stores user's data as data objects.

Opportunities memory 40 is structured, in one embodiment, as a relational database, it being understood that memory 40 should not be limited thereto. A relational database stores data in records and tables. A table typically contains a set of records. Each record has a set of columns, and each column in a record contains data. All records in the same table have the same set of columns. A column is often referred to as a field or attribute. Structured Query Language (SQL) is one of the most popular computer languages used with relational databases. Operations on relational databases, including operations to query, insert, update, and delete data from records, can be performed using SQL commands or statements. For example, commands called SQL queries can be used to retrieve data from one or more tables in a relational database for subsequent processing by software (e.g., forecasting system 10) executing on a computer system (e.g., server 12). When a SQL query is generated, there is no need to explicitly tell a database where to look for the data sought by the SQL query. It is enough to simply identify the data sought in the SQL query. Database management systems will take care of locating the data sought in response to receiving and implementing the SQL query.

Opportunities memory 40 stores opportunities as data objects. For the ease of illustration only, memory 40 stores each opportunity as one or more records in a relational database table, it being understood that the present invention should not be limited thereto. Each opportunity record consists of fields that contain data relating to a respective sales opportunity. Each opportunity record may include in respective fields: the name of a sales opportunity; an identity of a product to be sold in the sales opportunity; the quantity of the product to be sold in the sales opportunity; the expected close date of the sales opportunity; the revenue expected from the sale of the product(s); etc. A user of client 20 or 22 can create, modify, or delete an opportunity record in memory 40 using opportunity module 30.

Forecasts memory 44 stores forecasts that were generated by forecast generation module 34 using forecast definitions, respectively, that are stored in memory 42. Forecasts in memory 44 can be subsequently displayed on the monitor of client 20 or 22 in response to forecast presenter module 36 receiving a request from user via client system 20 or 22. More particularly, forecast presenter module 36 receives a request for a forecast from a user of client 20 or 22, retrieves the requested forecast from memory 44 in response to receiving the request, and presents the forecast for display on the monitor of client system 20 or 22. FIG. 6, which will be more fully described below, is an example of a displayed forecast.

A user of client 20 or 22 can create, modify, or delete a forecast definition in memory 42 using forecast definition module 34. Each forecast definition includes opportunity record field names that will be more fully described below. Each forecast definition also includes filter values which are used by forecast generation module 34 to identify opportunity records in memory 40 that are relevant to the forecast being generated. Forecast generation module 34 may generate a forecast for subsequent storage in memory 42 each time forecast definitions memory 42 receives a new forecast definition. Moreover, forecast generation module 34 may refresh an existing forecast in memory 44 each time an opportunity record relevant thereto, is updated or deleted, or each time a forecast definition is modified.

User's data memory 46 may contain a data object for each user of forecast system 10 including users of clients 20 and 22. These data objects identify information that is unique to respective users including, for example, the role of the user, the user's manager, the user's subordinates, the reporting hierarchy within an organization, etc, and other information that is needed by forecasting system 10. Forecasting system 10, in the example embodiment, is implemented on server 12 and configured to support multiple organizations. In this configuration, each user of a computer system, such as clients 20 and 22, may be assigned to an organization, and each user can only access the information of their organization.

In general, forecasting system 10 receives requests from users via network 24, and communication interface 26 may invoke the appropriate modules for processing each request. The invoked module may generate display pages that are provided to communications interface 26 for subsequent transmission to computer systems such as clients 20 or 22. The communications interface 26 in one embodiment may implement an HTTP-request and an HTTP-protocol.

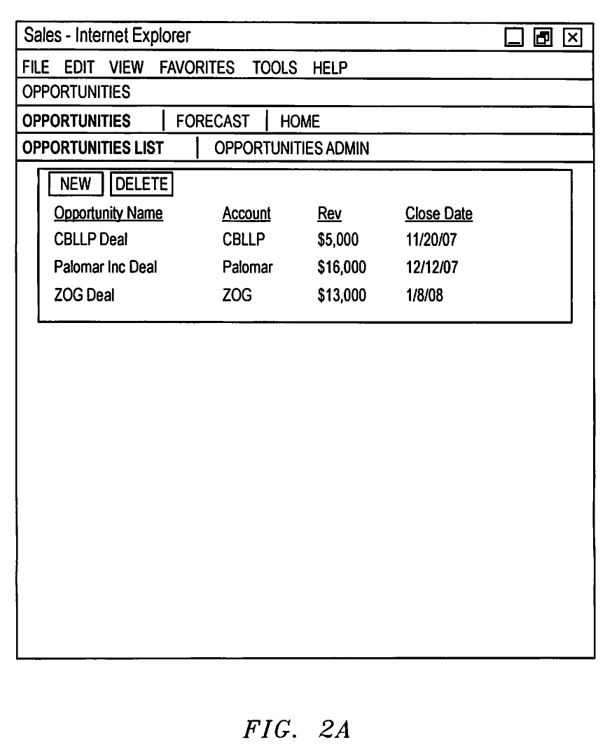

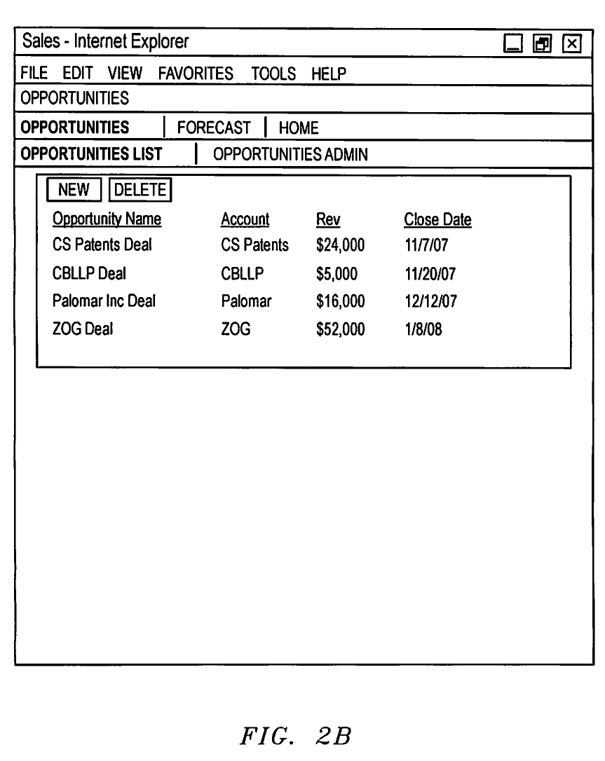

Once a user has logged into forecasting system 10 via client system 20 or 22, the user can request a list of his or her sales opportunities and/or the sales opportunities of the user's subordinates. FIG. 2A illustrates an example interface that can be displayed on the monitor of a computer system such as client 20 or 22 in response to the user requesting a listing of his or her opportunities. Each opportunity is represented in this interface as a line item in the list, and each line item contains information that is relevant to the corresponding opportunity. For example, the opportunity identified as “CBLPP Deal” is displayed along with the name of the account or customer (i.e., CBLLP), the revenue (i.e., $5,000) expected from the opportunity if the opportunity closes, and an anticipated close date (i.e., Nov. 20, 2007).

As noted above, a user may create, delete or update an opportunity record within memory 40 via opportunity module 30. From the interface shown in FIG. 2A, a user can navigate to an interface for modifying an existing opportunity, creating a new opportunity, or deleting an existing opportunity. For example, if the user clicks the “new” button, a command is sent to opportunity module 30. In response, opportunity module 32 presents the user interface 50 of FIG. 3A for display on the user's monitor, which can be used to enter data for a new opportunity.

Interface 50 includes areas 52 and 54 for entering data relevant to the new opportunity. Area 52 includes fields for entering: the name of the opportunity; the name of the account (or customer); the name of the sales representative responsible for the opportunity; an anticipated close date should the opportunity lead to an actual sale; the stage of the opportunity (e.g., lead, request for quote, negotiations, closing, etc.); the probability expressed as a percentage that the opportunity will result in a sale; and the business unit or organization to which the sales representative belongs. Data can be entered into the sales rep, sales stage, and business unit fields via respective drop down menus. It is noted that additional fields can be added to area 52, and interface 50 should not be limited to that shown in FIG. 3A.

Area 54 includes one or more lines for each product of the sales opportunity. Each line in area 54 includes fields for: the name of at least one product; the name of the product line; the quantity of the product; the net price of the product; and the revenue for the product or products. The name of the product or the name of the product line can be entered via a drip down menu. In one embodiment once a product name and quantity are entered into the empty product field of a line in area 54, the net price and revenue fields of the line are automatically and correctly populated. A user can add an additional line to area 54 by activating the “New” button. The user can add a plurality of lines to area 54 for a plurality of different products, respectively. FIG. 3B illustrates the interface 50 of FIG. 3A after the user enters information into the appropriate fields in accordance with a business opportunity named “CS Patents Deal.”

Once the user has entered all relevant data into interface 50, the entered data is downloaded to memory 40 via opportunity module 30 and stored as one or more opportunity records. One record will be created and stored in memory 40 for each line in area 54 that contains data, and each record will contain data entered in fields of area 52 and data entered into fields of a respective line in area 54. In the illustrated example, three opportunity records will be created and stored in memory 40. With reference to FIG. 3B, these three example records contain fields identified as: opportunity name, account name, sales rep, close date, sales stage, probability, business unit, product, product line, quantity, net price, and revenue. With continued reference to FIG. 3B, all three of the example opportunity records stored in memory 40 will have CS Patents Deal, CS Patents, Ryan, Nov. 7, 2007, 4-Negotiation, 90%, and Business Electronics in the opportunity name, account name, sales rep, close date, sales stage, probability, and business unit fields, respectively, thereof. The product and product fields of the first two example records will contain Dell-Desk-100 and Computers, respectively. The product and product fields of the third example record will contain Cisco 5150 and switches, respectively. The quantity, net price, and revenue fields of the first example record contains 10, $1,500, and $15,000, respectively. The quantity, net price, and revenue fields of the second example record contains 1, $3,000, and $3,000, respectively. The quantity, net price, and revenue fields of the third example record contains 1, $6,000, and $6,000, respectively.

FIG. 2B shows the user interface of FIG. 2A after data that was entered into the interface of FIG. 3B, was downloaded and stored in memory 40 as new records. Note the new opportunity identified as “CS Patents Deal” in FIG. 2B, which is the opportunity name entered into interface 50 of FIG. 3B. In the illustrated example, the opportunity named CS Patents Deal, is stored as the three example opportunity records described above.

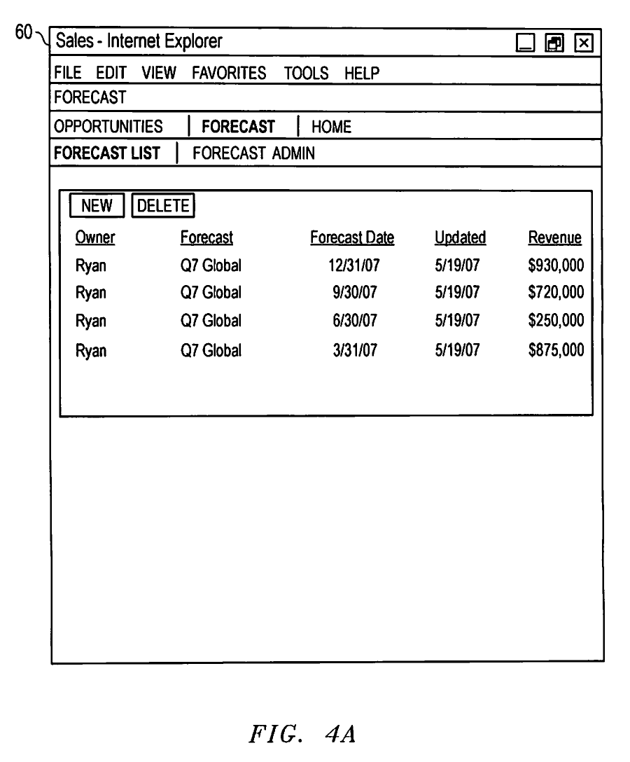

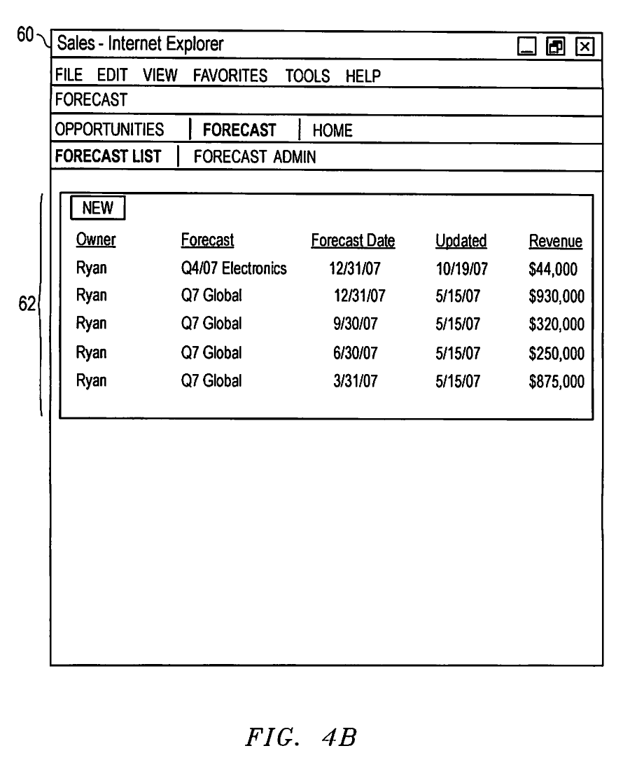

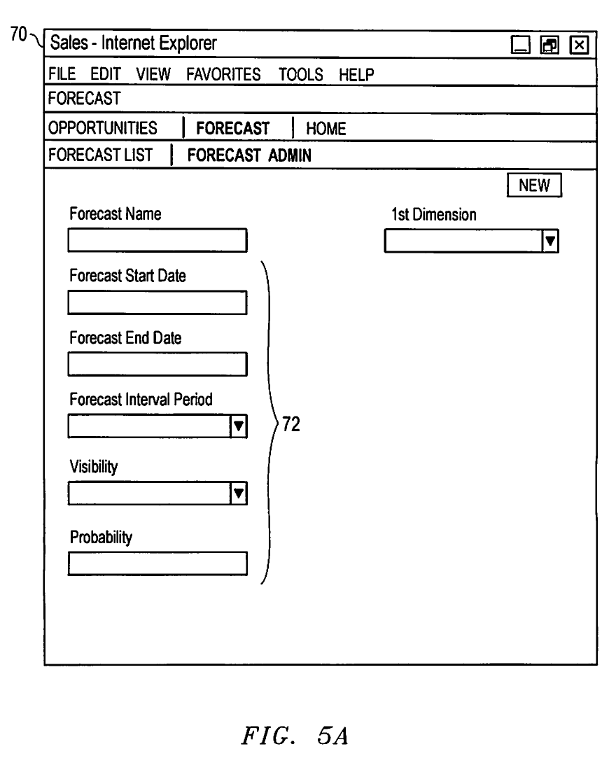

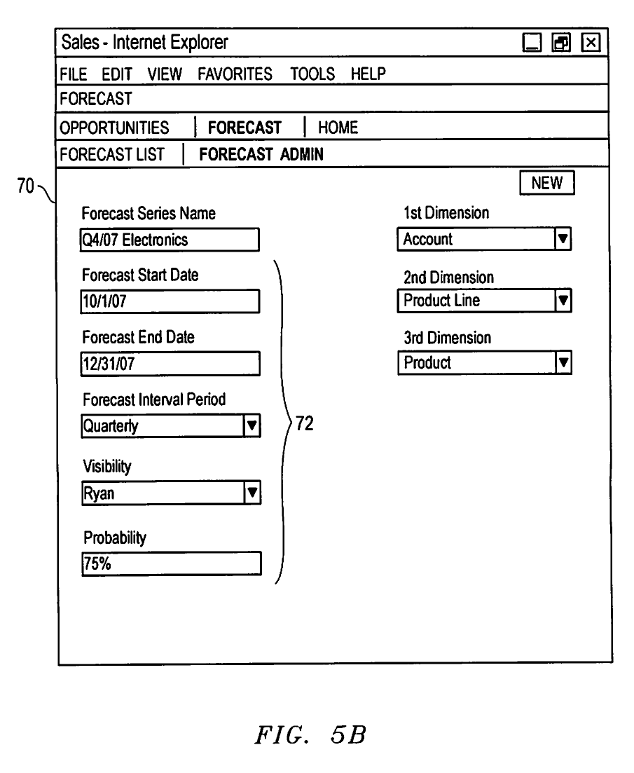

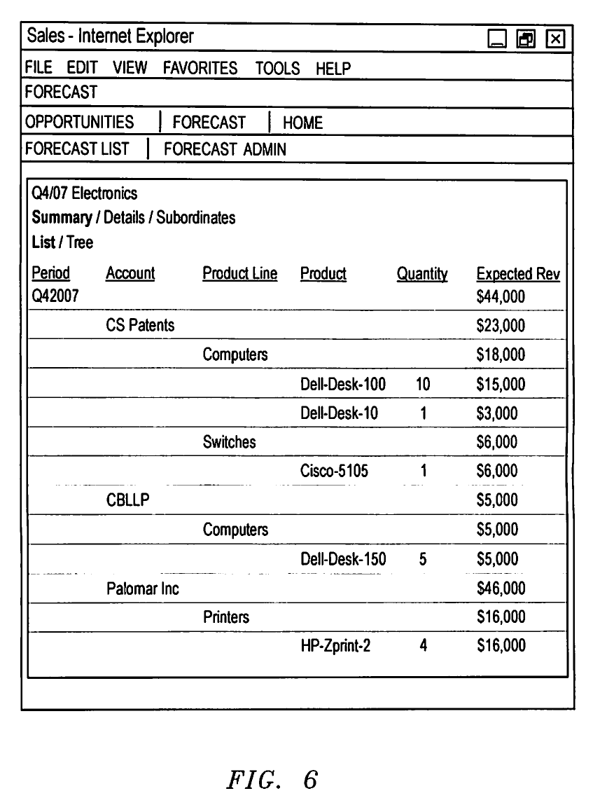

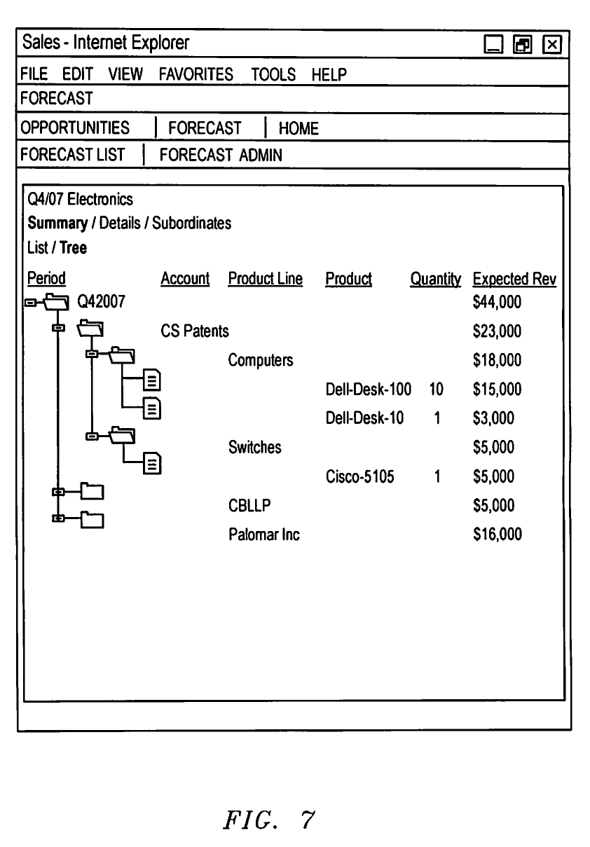

A user can navigate to an interface that lists the identities of existing forecasts, by activating the “Forecast” button of FIG. 2B. FIG. 4A illustrates an exemplary user interface 60 that can be displayed on the user's monitor after this button is activated. Interface 60 includes an area 62 that lists the identity of forecasts that are unique to the user and his/or subordinates. In this example, four forecasts are identified along with some information regarding each, including: the forecast name; the forecast date that corresponds to the last day of the forecast period; the expected revenue for the forecast; and the date when the forecast snapshot was last updated to include changes (i.e., deletions, additions, modifications) to opportunity records that are relevant to the forecast.

From interface 60, the user can navigate to another interface for creating a new forecast definition, which in turn can be used by forecast generation module 34 to create a new forecast. For example, if the user clicks the “New” button on interface 60 of FIG. 4A, forecast definition module 32, in response, will return a forecast definition interface such as interface 70 shown within FIG. 5A. This interface includes fields into which a user can enter the name of the forecast. The interface also includes area 72 having fields into which filter values can be entered. As noted above, the filter values are used by forecast generation module 34 to identify opportunity records in memory 40 that are relevant to the respective forecast to be created or updated. Lastly, interface 70 includes at least one field that is designated “Dimension” into which a name of an opportunity record field can be entered. Additional dimension fields for additional record field names can be added by activating the “New” button. As will be more fully described below, the entered record field names can be subsequently used to determine how forecast generation module 34 aggregates revenues of relevant opportunity records for subsequent display in a forecast.

A user can enter filter values into: the forecast start date field; the forecast end date field; the forecast interval period field; the visibility field; and the close probability field. It is noted that other filter value fields can be added to interface 70. The entered forecast start date and forecast end date identify the time period for the new forecast. In one embodiment, the starting and ending dates are selected to define a calendar year, a calendar quarter within the year, a particular month within the year, or a particular week in the year. A forecast interval period can be entered into that field using a drop down menu. A series of forecasts will be generated by forecast generation module 34 and stored in memory 44 if the entered forecast interval period is less than the forecast period. One forecast will be generated or each forecast period interval. The visibility field of FIG. 5B defines the user (e.g., sales rep) for whom the forecast snapshot is generated. If the user entered into the visibility field is a sales manager, then the forecast subsequently generated by forecast generation module 34 would be based not only the relevant sales manager's opportunities (i.e., opportunity records having the sales manager's name entered into the sales rep field), but would also be based on relevant opportunities for the sales manager's subordinates (i.e., opportunity records having the sales manager's subordinates names entered into the sales rep field). Forecast generation module can access user's data memory 46 to determine whether a name entered into the visibility field is a sales manager, and if so, the names of the sales manager's subordinates.

FIG. 5B shows the interface of FIG. 5A after a user enters filter values and display dimension values into respective fields for an example forecast entitled “Q4/07 Electronics.” In the illustrated embodiment, start and end dates of Oct. 1, 2007 and Dec. 31, 2007, respectively, are entered into the forecast start and end date fields, respectively. In the illustrated example, the forecast interval period is designated as “quarterly.” Since the entered forecast start and end dates of the illustrated example defines the fourth quarter of 2007, and since the forecast interval period is entered as “quarterly,” forecast generation module 34 will generate a single forecast once this example forecast definition is downloaded into forecast definitions memory 42. If, however, a smaller interval period such as “monthly” is entered into the forecast interval period field of FIG. 5B, then the forecast generation module 34, after the forecast definition is downloaded to memory 42, would generate a series of three forecasts, one for each of the months of the fourth quarter of 2007.

The user can enter opportunity record field names into the dimension fields of FIG. 5A or 5B using a drop down menu. The entered record field names correspond to opportunities fields that were described in FIG. 3A or 3B. FIG. 5B shows the interface of FIG. 5A after the user enters “account,” “product line,” and “product” into respective dimension fields. Ultimately, when the user has entered the last dimension name and/or filter value into interface 70, forecast definition module 32 can save the entered values and record field names as a forecast definition in memory 42. FIG. 4B illustrates the interface of FIG. 4A after the example forecast definition for Q4/07 Electronics has been saved in memory 42. As seen in FIG. 4B, the listing of forecasts now shows “Q4/07 Electronics,” which is the name of the forecast entered into the forecast name field of FIG. 5D.

After forecast definition module 32 stores a new or updated forecast definition into memory 42, forecast generation module 34 accesses the new or updated definition to read the filter values and record field names (i.e., the record names entered into the dimension fields) thereof. Forecast generation module 34 then generates the forecast or a series of forecasts in accordance with the filter values and record field names. More particularly, forecast generation module 34 accesses memory 40 and identifies all relevant opportunity records for the forecast. Relevant records are those that contain data in fields that meet the respective filter values of the forecast definition. For the example definition for Forecast Q4/07 Electronics that is shown in FIG. 5B, generation module 34 would identify as relevant, all opportunity records in memory 40 that have (1) a date in the close field that falls between forecast start date Oct. 1, 2007 and forecast end date Dec. 31, 2007, and (2) a name in the visibility field that matches “Ryan” or any subordinate of Ryan, and (3) a value in the probability field that is 75% or greater.

Data, including revenue data, from the relevant opportunity records are processed by generation module 34, the results of which are subsequently stored as a corresponding forecast in memory 44. First, a total forecast revenue is calculated by adding the revenue values in the revenue fields of each of the relevant opportunity records. Then, one or more first dimension revenues are calculated. Each first dimension revenue is calculated by adding the revenue in the revenue field of all relevant records that contain the same name in the field that is identified by the first entered dimension (i.e., the first record field name) of the forecast definition. In the example forecast definition of FIG. 5B, “Account” is the first record field name since it is the first entered dimension. The first dimension revenues should add up to equal the total forecast revenue. In the illustrated example, if there are x different names in the Account fields of the relevant opportunity records, then generation module 34 will calculate x first dimension revenues.

Second dimension revenues can then be calculated, if the forecast definition has more than one record field name entered as a dimension. Each second dimension revenue is calculated by adding the revenue in the revenue field of all relevant records that contain the same name in the field that is identified by the first entered dimension (i.e., the first record field name) of the forecast definition and the same name in the field that is identified by the second entered dimension (i.e., the second record field name) of the forecast definition. In the example forecast definition of FIG. 5B, “Product Line” is the second record field name since it is the second entered dimension. The second dimension revenues should add up to equal the total forecast revenue.

Third dimension revenues can be calculated, if the forecast definition has more than two record field names entered as dimensions. Each third dimension revenue is calculated by adding the revenue in the revenue field of all relevant records that contain the same name in the field that is identified by the first entered dimension (i.e., the first record field name) of the forecast definition, the same name in the field that is identified by the second entered dimension (i.e., the second record field name) of the forecast definition, and the same name in the field that is identified by the third entered dimension (i.e., the third record field name) of the forecast definition. In the example forecast definition of FIG. 5B, “Product” is the third record field name since it is the third entered dimension. The third dimension revenues should add up to equal the total forecast revenue. Additional dimension revenues can be calculated in similar fashion, if the forecast definition has more than three record field names entered as dimensions. After all of the dimension revenue values have been calculated, the calculated revenue values and the various names entered into the fields of the relevant records that are defined by the entered dimensions, are stored in the forecast memory as a forecast.

Existing forecasts stored in memory 44 can be displayed on a monitor of a computer system such as client 20 or 22. With reference to FIGS. 1 and 4B, client 20 or 22 can send to forecast presenter module 36 a request for a forecast that is designated by a user within the list of forecasts, for example, shown in interface 60 of FIG. 4B. Forecast presenter module 36 accesses forecast memory 44 to retrieve the corresponding forecast, which includes the calculated revenue values, names of fields, etc., described above. Thereafter, forecast presenter module 36 presents the requested forecast to client 20 or 22 for display on the monitor thereof.

FIG. 6 illustrates an example forecast displayed on monitor 20 or 22 in response to the forecast presenter module 36 receiving a request for the Q4/07 Electronics forecast. As seen in FIG. 6, the record field names entered as dimensions in FIG. 5B are shown as headers in the Q4/07 Electronics forecast along with headers designated “quantity” and “expected revenue.” Names (e.g., CS Patents, CBLLP, Computers, Switches, Cisco-5150) from fields of the relevant records are logically positioned underneath the appropriate headers.

The Q4/07 Electronics forecast shown in FIG. 6 also includes the calculated revenue values. For example, the calculated total revenue value (e.g., 44,000) for the forecast period is displayed. The calculated first dimension revenue values of $23,000, $5,000, and $46,000 are displayed on the same line as CS Patents, CBLLP, and Palomar Inc., respectively, which are the names from relevant records in the field that is identified by the first dimension (i.e., Accounts) of the example forecast definition that is shown in FIG. 5B. The calculated second dimension revenue values of $18,000, $6,000, $5,000, and $16,000 are displayed on the same line as Computers, Switches, and Computers, and Printers respectively, which are the names from relevant records in the field that is identified by the second dimension (i.e., Product Line) of the example forecast definition that is shown in FIG. 5B. Lastly, third dimension revenue values of $15,000, $3,000, $6,000, $5,000, and $16,000 are displayed on the same line as Dell-Desk-100, Dell-Desk-10, Cisco-5150, Dell-Desk-150, and HP-Zprint-2, respectively, which are the names from relevant records in the field that is identified by the third dimension (i.e., Product) of the example forecast definition that is shown in FIG. 5B.

FIG. 6 shows the forecast in a “list view.” The user can navigate to a different view of the forecast. For example, if the user activates the “tree” button on the interface shown on FIG. 6, the interface shown on FIG. 7 will be displayed. Here, the forecast is seen as a hierarchy of folders, some of which are open to provide insight into their contents. Ultimately, the same information is provided in the tree view as is provided in the list view of FIG. 6.

One of ordinary skill in the art can see that the forecast shown in FIG. 6, sales representatives and managers can view forecasted product revenues and quantities grouped by different dimensions. This allows sales managers or sales representatives to easily view forecasted revenues and quantities that are grouped by different dimensions such as product or product line and provides a greater insight into how total product revenue and quantity are aggregated. This enables companies that deliver product or sale expiring inventory to understand the future demand of their products at the product level and can significantly increase the effect in this of their production and resource planning.

1. A method comprising:
accessing a database to select a set of data objects each of which has a date field that contains a date that falls within a predefined time period;
summing data contained in a first field of each of the set of data objects thereby generating a first total;
summing the data contained in the first field of each of a first subset of the set of data objects thereby generating a first subset total;
displaying a user interface on a monitor of a computer system, wherein the user interface, when displayed, comprises graphical representations of the first total and the first subset total.

2. The method of claim 1 further comprising:
summing data contained in a second field of each of the set of data objects thereby generating a second total;
summing the data contained in the second field of each of the first subset of the set of data objects thereby generating a second subset total;
wherein the user interface, when displayed, comprises graphical representations of second total and the second subset total.

3. The method of claim 2 wherein each of the set of data objects comprise a third field, wherein the third field of each of the first subset of data objects comprises data that matches a first predefined value.

4. The method of claim 3 further comprising:
summing the data contained in the first field of each of a second subset of the set of data objects thereby generating a third subset total, wherein the data objects of the first subset are distinct from the data objects in the second subset;
summing the data contained in the second field of each of the second subset of the set of data objects thereby generating a fourth subset total;
wherein the user interface, when displayed, comprises graphical representations of the third subset total and the fourth subset total.

5. The method of claim 4 wherein the third field of each of the second subset of data objects comprises data that matches a second predefined value.

6. The method of claim 5 further comprising:
summing the data contained in the first field of each of a subset of the first subset thereby generating a subset total of the first subset total;
summing the data contained in the second field of each of a subset of the second subset thereby generating a subset total of the second subset total;
wherein the user interface, when displayed, comprises graphical representations of the subset total of the first subset total and the subset total of the second subset total.

7. The method of claim 6 wherein each of the set of data objects comprise a fourth field, wherein the fourth field of each data object of the subset of the first subset of data objects comprises data that matches a third predefined value.

8. The method of claim 7 wherein the data of the first field in each of the set of data objects, represents revenue from a sale or potential sale of one or more products to a customer.

9. The method of claim 8 wherein the data of the second field in each of the set of data objects, represents revenue from a sale or potential sale of one or more products to a customer.

10. The method of claim 5 wherein the first and second predefined values comprise first and second names, respectively, of first and second products, respectively, for sale or sold by a company.

11. A computer readable medium storing instructions, wherein a method is implemented when the instructions are executed, method comprising:
accessing a database to select a set of data objects each of which has a date field that contains a date that falls within a predefined time period;
summing data contained in a first field of each of the set of data objects thereby generating a first total;
summing the data contained in the first field of each of a first subset of the set of data objects thereby generating a first subset total.

12. The computer readable medium of claim 1 wherein the method further comprises:
summing data contained in a second field of each of the set of data objects thereby generating a second total;
summing the data contained in the second field of each of the first subset of the set of data objects thereby generating a second subset total.

13. The computer readable medium of claim 12 wherein each of the set of data objects comprise a third field, wherein the third field of each of the first subset of data objects comprises data that matches a first predefined value.

14. The computer readable medium of claim 13 wherein the method further comprises:
summing the data contained in the first field of each of a second subset of the set of data objects thereby generating a third subset total, wherein the data objects of the first subset are distinct from the data objects in the second subset;
summing the data contained in the second field of each of the second subset of the set of data objects thereby generating a fourth subset total.

15. The computer readable medium of claim 14 wherein the third field of each of the second subset of data objects comprises data that matches a second predefined value.

16. The computer readable medium of claim 15 wherein the method further comprises:
summing the data contained in the first field of each of a subset of the first subset thereby generating a subset total of the first subset total;
summing the data contained in the second field of each of a subset of the second subset thereby generating a subset total of the second subset total;
wherein the user interface, when displayed, comprises graphical representations of the subset total of the first subset total and the subset total of the second subset total.

17. The computer readable medium of claim 16 wherein each of the set of data objects comprise a fourth field, wherein the fourth field of each data object of the subset of the first subset of data objects comprises data that matches a third predefined value.

18. The computer readable medium of claim 17 wherein the data of the first field in each of the set of data objects, represents revenue from a sale or potential sale of one or more products to a customer.

19. The computer readable medium of claim 18 wherein the data of the second field in each of the set of data objects represents revenue from a sale or potential sale of one or more products to a customer.

20. The computer readable medium of claim 15 wherein the first and second predefined values comprise first and second names, respectively, of first and second products, respectively, for sale or sold by a company.

21. An apparatus comprising:
a first circuit for accessing a database to select a set of data objects each of which has a date field that contains a date that falls within a predefined time period;
a second circuit for summing data contained in a first field of each of the set of data objects thereby generating a first total;
a third circuit for summing the data contained in the first field of each of a first subset of the set of data objects thereby generating a first subset total;
a monitor for displaying a user interface on a monitor of a computer system, wherein the user interface, when displayed, comprises graphical representations of the first total and the first subset total.
